(19) United States
(12) Patent Application Publication
(10) Pub. No.: US 2015/0198734 A1
(43) Pub. Date: Jul. 16, 2015

(54) APPARATUS AND METHOD FOR DETECTING LOCATION OF BURIED PIPE

(71) Applicant: ELECTRONICS AND TELECOMMUNICATIONS RESEARCH INSTITUTE, Daejeon-city (KR)

(72) Inventors: Sang-Mu LEE, Daejeon (KR); Mun-Hwan CHOI, Daejeon (KR)

(21) Appl. No.: 14/295,716

(22) Filed: Jun. 4, 2014

(30) Foreign Application Priority Data
Jan. 10, 2014 (KR) 10-2014-0003315

(51) Int. Cl. G01V 3/10

(52) U.S. Cl. CPC G01V 3/10

(57) ABSTRACT

A method and apparatus for detecting the location of a buried pipe are disclosed. The apparatus includes an inductive source setting unit, an induced voltage measurement unit, a proportional graph generation unit, and a location determination unit. The inductive source setting unit sets an inductive source in a predetermined area which a location of a buried pipe is detected. The induced voltage measurement unit measures the induced voltages of conductive wires for measuring the induced voltages in the predetermined area based on the inductive source. The proportional graph generation unit generates a proportional graph using the measured induced voltages. The location determination unit detects the location of the buried pipe using the proportional graph.

### CROSS REFERENCE TO RELATED APPLICATION

This application claims the benefit of Korean Patent Application No. 10-2014-0003315 filed on Jan. 10, 2014, which is hereby incorporated by reference in its entirety into this application.

### BACKGROUND OF THE INVENTION

1. Technical Field

The present invention relates generally to an apparatus and method for detecting the location of a buried pipe and, more particularly, to an apparatus and method for detecting the location of a buried pipe, formed of an electrical conductor, using electromagnetic induction voltages.

2. Description of the Related Art

Conventionally, to detect whether a buried pipe is present, a method of applying electromagnetic waves at an estimated location above a buried pipe and then analyzing the shape of reflected reflection waves has been used.

By way of example, Koran Patent Application Publication No. 10-2002-0096270 entitled “Method and Apparatus For Detecting Buried Pipe” discloses technology that is capable of performing a test operation for detecting a buried pipe by varying the frequency and voltage of electromagnetic waves radiated by a transmission antenna, setting electromagnetic waves having a frequency and voltage capable of detecting the buried pipe using an image of reflected waves, and then performing the detecting of the buried pipe.

However, the conventional technology is problematic in that detection should be performed after the location of the buried pipe has been estimated and detection should be performed while the estimated location of the buried pipe is being repetitively changed if the buried pipe has been not located through first detection. Furthermore, the conventional technology is problematic in that dedicated measuring equipment capable of generating electromagnetic waves that should be radiated so as to detect an underground pipe should be provided. Moreover, the conventional technology is problematic in that, if a buried pipe has a very large size, that is, a buried pipe has a radius of one meter, it is difficult to determine the shape of the buried pipe using small-sized equipment.

### SUMMARY OF THE INVENTION

Accordingly, the present invention has been made keeping in mind the above problems occurring in the conventional art, and an object of the present invention is to provide an apparatus and method for detecting the location of a buried pipe formed of an electrical conductor using electromagnetic induction voltages.

In accordance with an aspect of the present invention, there is provided a method of detecting the location of a buried pipe, including setting an inductive source in a predetermined area in which the location of a buried pipe is detected; measuring the induced voltages of conductive wires for measuring the induced voltages in the predetermined area based on the inductive source; generating a proportional graph using the measured induced voltages; and detecting the location of the buried pipe using the proportional graph.

Detecting the location of the buried pipe may include, if it is determined based on the proportional graph that a peak of the voltages of the inductive source that are generated at locations spaced apart from the inductive source does not occur at a location closest to the inductive source but occurs at another horizontal location, determining that the buried pipe is located in the other horizontal location.

Generating the proportional graph may include generating the proportional graph including a horizontal axis representative of the locations of the inductive source and the buried pipe and a vertical axis representative of efficiency obtained by normalizing a relationship between relative induced voltages.

Setting the inductive source may include setting an inductive source line including a distribution line for supplying electric power to consumers in the predetermined area or an electric car wire of an AC electric railcar system, as the inductive source.

In accordance with another aspect of the present invention, there is provided an apparatus for detecting the location of a buried pipe, including an inductive source setting unit configured to set an inductive source in a predetermined area which the location of a buried pipe is detected; an induced voltage measurement unit configured to measure the induced voltages of conductive wires for measuring the induced voltages in the predetermined area based on the inductive source; a proportional graph generation unit configured to generate a proportional graph using the measured induced voltages; and a location determination unit configured to detect the location of the buried pipe using the proportional graph.

The location determination unit, if it is determined based on the proportional graph that a peak of the voltages of the inductive source that are generated at locations spaced apart from the inductive source does not occur at a location closest to the inductive source but occurs at another horizontal location, may determine that the buried pipe is located in the other horizontal location.

The proportional graph generation unit may generate the proportional graph including a horizontal axis representative of the locations of the inductive source and the buried pipe and a vertical axis representative of efficiency obtained by normalizing a relationship between relative induced voltages.

The inductive source setting unit may set an inductive source line including a distribution line for supplying electric power to consumers in the predetermined area or an electric car wire of an AC electric railcar system, as the inductive source.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a configuration for measuring induced voltages according to an embodiment of the present invention;

FIG. 2 is a side view of lines for measuring induced voltages according to an embodiment of the present invention;

FIG. 3 is a diagram schematically illustrating an apparatus for detecting the location of a buried pipe according to an embodiment of the present invention;

FIG. 4 is a reference diagram illustrating a proportional graph required to detect the location of a buried pipe according to an embodiment of the present invention; and

FIG. 5 is a flowchart illustrating a method of detecting the location of a buried pipe according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

An apparatus and method for detecting the location of a buried pipe according to embodiments of the present invention will be described in detail below with reference to the attached drawings.

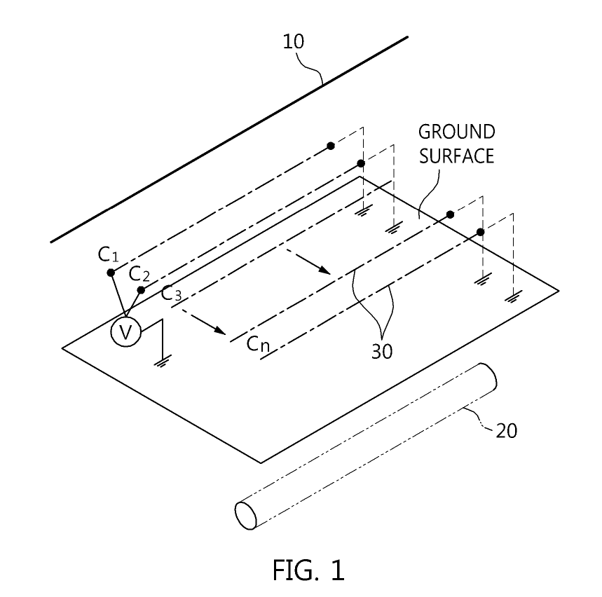

An apparatus for detecting the location of a buried pipe according to an embodiment of the present invention, as illustrated in FIG. 1, measures the induced voltages of multiple lines in a ground area in which a buried pipe is estimated to be located, and then detects the distribution of the multiple lines based the measured induced voltages, thereby detecting the location of the buried pipe.

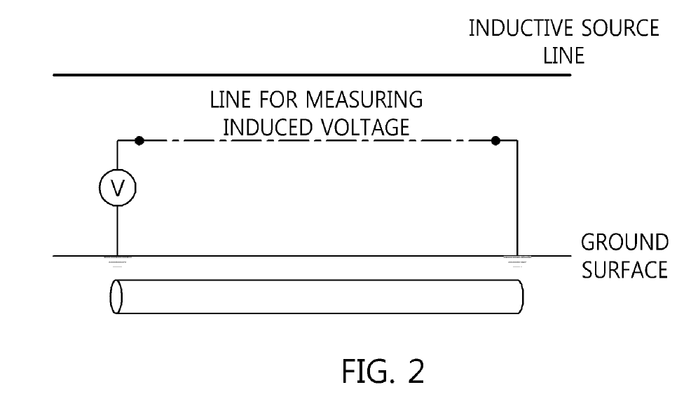

FIG. 1 is a perspective view of a configuration for measuring induced voltages according to an embodiment of the present invention. FIG. 2 is a side view of lines for measuring induced voltages according to an embodiment of the present invention.

First, in order to measure induced voltages, there should be an inductive source 10.

In general, the inductive source 10 means a power line. The power line may be a distribution line for supplying electric power to consumers, or an inductive source line, such as an electric car wire of an alternating current (AC) electric railcar system. Therefore, in order to attain the object of the present invention, which is to provide an apparatus and method for detecting the location of a buried pipe formed of an electrical conductor using electromagnetic induction voltages, the inductive source may be artificially installed, but the inductive source is not limited thereto.

The apparatus for detecting the location of a buried pipe according to the embodiment of the present invention sequentially or concurrently measures the induced voltages of conductive wires (that is, the lines for measuring induced voltages illustrated in FIG. 2) 30 at regular intervals within a range covering the buried pipe based on the known inductive source in a ground area in which the buried pipe is estimated to be located. Thereafter, the apparatus for detecting the location of a buried pipe generates a proportional graph using the measured induced voltages, and detects the location of the buried pipe based on the generated proportional graph.

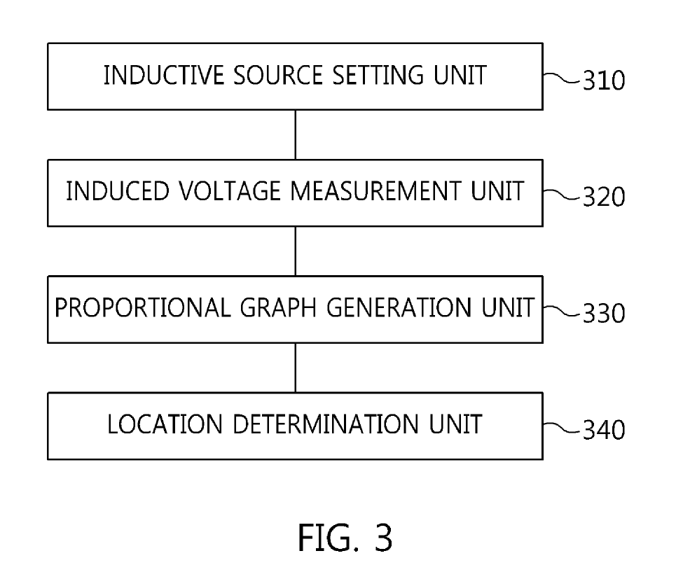

Next, the apparatus for detecting the location of a buried pipe will be described in detail with reference to FIG. 3.

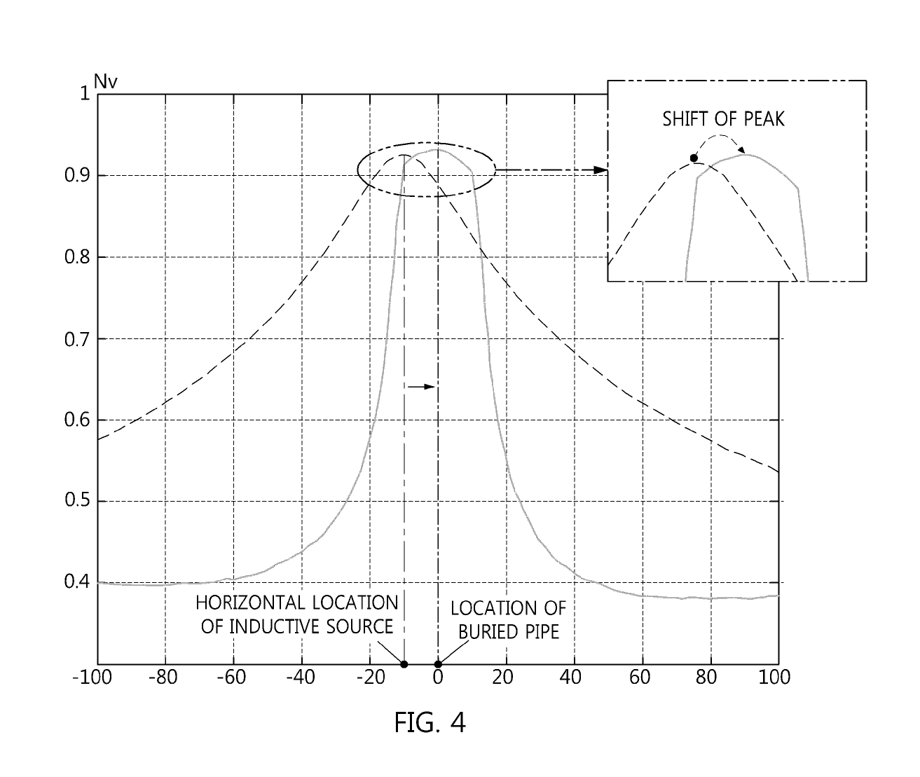

FIG. 3 is a diagram schematically illustrating an apparatus for detecting the location of a buried pipe according to an embodiment of the present invention. FIG. 4 is a reference diagram illustrating a proportional graph required to detect the location of a buried pipe according to an embodiment of the present invention.

Referring to FIG. 3, the apparatus for detecting the location of a buried pipe includes an inductive source setting unit 310, an induced voltage measurement unit 320, a proportional graph generation unit 330, and a location determination unit 340.

The inductive source setting unit 310 sets an inductive source in a predetermined area in which the location of the buried pipe is detected. The inductive source may be a distribution line for supplying electric power to consumers in the predetermined area, or an inductive source line, such as an electric car wire of an AC electric railcar system, and is limited thereto.

The induced voltage measurement unit 320 measures the induced voltages of respective conductive wires (that is, the lines for measuring induced voltages illustrated in FIG. 2) 30 for measuring the induced voltages in the predetermined area based on the inductive source set by the inductive source setting unit 310.

The proportional graph generation unit 330 generates a proportional graph using the induced voltages measured by the induced voltage measurement unit 320.

Referring to FIG. 4, the proportional graph includes a horizontal axis x representative of the locations of the inductive source and the buried pipe and a vertical axis Ny representative of efficiency obtained by normalizing the relationship between relative induced voltages.

If a buried pipe is not present, the curve of the proportional graph illustrating changes in induced voltage is represented by a dotted line. In this case, the peak of the induced voltages occurs at the horizontal location of the original inductive source. Meanwhile, if a buried pipe is present, the curve of the proportional graph illustrating changes in induced voltage is represented by a solid line.

That is, if a buried pipe is present, the peak of the induced voltages shifts from the location of the peak of the original induced voltages to a horizontal coordinate at which the buried pipe is present.

Therefore, referring to the changes in induced voltage illustrated in FIG. 4, if it is determined based on the proportional graph that a peak of the voltages of the inductive source that are generated at locations spaced apart from the inductive source does not occur at a location closest to the inductive source but occurs at another horizontal location, it is determined that the buried pipe is located in the other horizontal location.

The location determination unit 340 determines the location of the buried pipe using the proportional graph generated by the proportional graph generation unit 330.

For example, the location determination unit 340, if it is determined based on the proportional graph of FIG. 4 that a peak of the voltages of the inductive source that are generated at locations spaced apart from the inductive source does not occur at a location closest to the inductive source but occurs at another horizontal location, determines that the buried pipe is located in the other horizontal location.

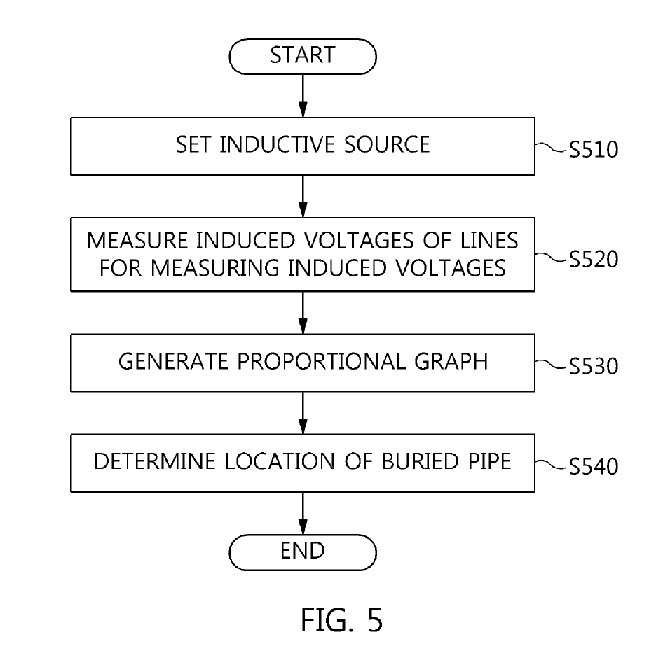

Next, a method of detecting the location of the buried pipe according to an embodiment of the present invention will be described in detail in reference to FIG. 5.

FIG. 5 is a flowchart illustrating a method of detecting the location of a buried pipe according to an embodiment of the present invention.

Referring to FIG. 5, the apparatus for detecting the location of a buried pipe sets an inductive source in a predetermined area in which the location of a buried pipe is detected at step S510. The inductive source may be a distribution line for supplying electric power to consumers in the predetermined area, or an inductive source line, such as an electric car wire of an AC electric railcar system, but is not limited thereto.

At step S520, the apparatus for detecting the location of a buried pipe measures the induced voltages of respective conductive wires (that is, the lines for measuring induced voltages illustrated in FIG. 2) 30 for measuring the induced voltages in the predetermined area based on the inductive source set at step S510.

At step S530, the apparatus for detecting the location of a buried pipe generates a proportional graph illustrated in FIG. 4 using the induced voltages measured at step S520.

In this case, the proportional graph includes a horizontal axis x representative of the locations of the inductive source and the buried pipe and a vertical axis Ny representative of efficiency obtained by normalizing the relationship between relative induced voltages.

If a buried pipe is not present, the curve of the proportional graph illustrating changes in induced voltage is represented by a dotted line. The peak of the induced voltages occurs at the horizontal location of the original inductive source. Meanwhile, if a buried pipe is present, the curve of the proportional graph illustrating changes in induced voltage is represented by a solid line.

That is, if a buried pipe is present, the peak of the induced voltages shifts from the location of the peak of the original induced voltages to a horizontal coordinate at which the buried pipe is present.

At step S540, the apparatus for detecting the location of a buried pipe detects the location of the buried pipe using the proportional graph generated at step S530.

For example, the location determination unit 340, if it is determined based on the proportional graph of FIG. 4 that a peak of the voltages of the inductive source that are generated at locations spaced apart from the inductive source does not occur at a location closest to the inductive source but occurs at another horizontal location, determines that the buried pipe is located in the other horizontal location.

As described above, in accordance with the present invention, the location of a buried pipe formed of an electrical conductor is detected using electromagnetic induction voltages, so that expensive dedicated measuring equipment is not used and detecting does not need to be performed while the estimated location of dedicated measuring equipment is repetitively being changed so as to detect the location of the buried pipe. Furthermore, in accordance with the present invention, the location of the buried pipe can be detected in such a way that an unknown parameter for detecting a shape based on the radius of the buried pipe is excluded and only the horizontal distribution of induced voltages is detected using the fact that a power line is positioned around a desired site regardless of the size of the buried pipe.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of detecting a location of a buried pipe, comprising:
setting an inductive source in a predetermined area in which a location of a buried pipe is detected;
measuring induced voltages of conductive wires for measuring the induced voltages in the predetermined area based on the inductive source;
generating a proportional graph using the measured induced voltages; and
detecting the location of the buried pipe using the proportional graph.

2. The method of claim 1, wherein detecting the location of the buried pipe comprises, if it is determined based on the proportional graph that a peak of the voltages of the inductive source that are generated at locations spaced apart from the inductive source does not occur at a location closest to the inductive source but occurs at another horizontal location, determining that the buried pipe is located in the other horizontal location.

3. The method of claim 1, wherein generating the proportional graph comprises generating the proportional graph including a horizontal axis representative of the locations of the inductive source and the buried pipe and a vertical axis representative of efficiency obtained by normalizing a relationship between relative induced voltages.

4. The method of claim 1, wherein setting the inductive source comprises setting an inductive source line including a distribution line for supplying electric power to consumers in the predetermined area or an electric car wire of an AC electric railcar system, as the inductive source.

5. An apparatus for detecting a location of a buried pipe, comprising:
an inductive source setting unit configured to set an inductive source in a predetermined area which a location of a buried pipe is detected;
an induced voltage measurement unit configured to measure induced voltages of conductive wires for measuring the induced voltages in the predetermined area based on the inductive source;
a proportional graph generation unit configured to generate a proportional graph using the measured induced voltages; and
a location determination unit configured to detect the location of the buried pipe using the proportional graph.

6. The apparatus of claim 5, wherein the location determination unit, if it is determined based on the proportional graph that a peak of the voltages of the inductive source that are generated at locations spaced apart from the inductive source does not occur at a location closest to the inductive source but occurs at another horizontal location, determines that the buried pipe is located in the other horizontal location.

7. The apparatus of claim 5, wherein the proportional graph generation unit generates the proportional graph including a horizontal axis representative of the locations of the inductive source and the buried pipe and a vertical axis representative of efficiency obtained by normalizing a relationship between relative induced voltages.

8. The apparatus of claim 5, wherein the inductive source setting unit sets an inductive source line including a distribution line for supplying electric power to consumers in the predetermined area or an electric care wire of an AC electric railcar system, as the inductive source.
